(19) United States
(12) Patent Application Publication
(10) Pub. No.: US 2012/0282405 A1
(43) Pub. Date: Nov. 8, 2012

(54) DEVICE AND METHOD FOR PRESERVING COMPONENTS

(76) Inventor: Frank Herre, Oberriexingen (DE)

(21) Appl. No.: 13/509,110

(22) PCT Filed: Nov. 11, 2010
(86) PCT No.: PCT/EP10/06880

§ 371 Date: Jul. 16, 2012

(30) Foreign Application Priority Data
Nov. 11, 2009 (DE) 10 2009 052 654.4

(51) Int. Cl. B05D 3/10; B05C 11/00; B05D 1/02; B05C 5/00

(52) U.S. Cl. 427/337; 118/300; 118/313; 118/612

(57) ABSTRACT

Devices for preserving components with a preservative agent, e.g., for cavity preservation of motor vehicle body components, are disclosed. An exemplary device, in addition to a preservative agent, may apply a hardener configured to react with the preservative agent, which causes the preservative agent to harden.

The invention relates to a device and a method for preserving components with a preservative agent. The invention is preferably used in the preservation of hard-to-reach surfaces to be preserved, which is the case e.g. in cavity preservation, seam sealing (e.g. flange seams), etc. of motor vehicle body components.

Cavity preservation, i.e. the preservation of an inner surface of a cavity, is generally used with high quality vehicles to significantly extend the corrosion protection. The use of cavity preservation is typical, particulary, in countries in which high commitments are made with regard to the so-called “rust-through warranty” (corrosion protection warranty), as is the case in many European countries. Some vehicles which are imported into such countries, if they have not already undergone cavity preservation, undergo cavity preservation retrospectively.

Cavity preservation cannot now be omitted, in particular in the case of high quality vehicles with high corrosion protection warranties.

There are essentially two methods known for the cavity preservation of motor vehicle bodies, namely the flood-coating method and the spray method.

In the flood-coating method, the cavities of the motor vehicle body to be preserved are flooded with solvent-free wax which has been made liquid by heating, wherein a portion of the wax deposits on the cavity walls and thereby preserves them while the excess wax runs off.

In the spray method for cavity preservation, however, the wax used as the preservative agent is sprayed onto the inner walls of the cavities, for which purpose can be used an application tube (lance), for example, which is inserted from the outside into the cavity and which has outlet openings for the wax.

A wax is usually used as the material for cavity preservation. Typical in the prior art is a processing method wherein the wax is pre-atomized together with air in an pre-atomizing chamber and is fed to the body by means of air through tubes (e.g. of length 3-8 m). The air serves for the atomization, the transport and the distribution within the cavity. The wax is conveyed into the cavity and should usually seal it. To do so it needs to spread. This is generally supported by a tipping station, which “tips” the body part such as to support the spreading (penetration) of the wax. Openings (outlet holes) in the body part to be preserved indicate that the cavity has been successfully coated.

A disadvantage of this method is that escaping wax is undesirable and can contaminate, in particular, subsequent conveyor regions.

This disadvantage is minimized by providing a wax dryer. Said wax dryer heats the body parts to a predetermined minimum temperature over a predetermined minimum period e.g. 1 min. at 60° C. A normal wax dryer length is e.g. 60 m. After the drying process, the escaping of wax is essentially stopped. One also speaks in this context of the so-called “drop-stop”. The wax hardens a few weeks/days longer but never becomes completely solid, rather remaining flexible. A series of disadvantages is associated with this type of wax dryer, e.g. high energy consumption during the operation, high investment and/or maintenance costs, high costs of cleaning, large space requirement, cannot be retrofitted in the case of many customers, etc.

The documents DE 35 18 584 A1, GB 2 251 396 A, EP 2 067 530 A1, DE 36 16 235 C2, EP 1 795 282 A1, DE 31 42 154 C2, EP 2 098 302 A1 and U.S. Pat. No. 4,703,894 A provide further technological background with regard to the invention.

The object of the invention is to create an improved device and an improved method for the preservation of components. It should be possible in particular after the application of the preservative agent and optional subsequent penetration to achieve a “drop-stop” in a short time and/or without a dryer resp. furnace. In the case of cavity preservation, for example, it should be possible to prevent preservative agent from escaping from the cavity to be preserved in a simple manner.

This object is achieved by the features of the independent claims.

The invention comprises the general technical teaching to mix a preservative agent and a hardener during the preservation of components in order to cause the preservative agent to harden faster, in particular, to achieve a “drop-stop”.

The device according to the invention for preserving components with a preservative agent is characterized in particular in that, in addition to the preservative agent, a hardener is applied, which reacts with the preservative agent to cause the preservative agent to harden. The device is thereby preferably provided in order to apply a hardener in addition to the preservative agent in order to react with the preservative agent, whereby a hardening of the preservative agent is achievable.

It is particularly advantageous in that no dryer resp. furnace is required to achieve a “drop-stop”.

A further advantage of the invention is that the device can be formed in such a way that no or very few sections of the device come into contact with a mixture of preservative agent and hardener. The preservative agent hardens by means of the hardener after the mixing process. A normal mixer cannot be located directly inside the nozzle for space reasons but would have to be mounted a few centimeters to meters away from the nozzle. Since the hardener reacts with water, the water or the residual moisture from the air/compressed air is sufficient to initiate a reaction. In the process of blowing out the feed line after pre-atomizing and/or mixing, residues would remain in the feed line which could no longer be fully discharged even in the case of subsequent coating processes. Even rinsing would not make the feed line and other contaminated device parts 100% clean. Thus, residues would remain and would harden, which is associated with a series of problems. The following issues are highlighted as being particularly problematic: Clogging of the nozzles, changing of the nozzle geometry by deposits, changing of the application result, malfunction/failure of individual components (e.g. valves), pressure losses, leakages at junctions (e.g. at interchangeable heads), etc. Furthermore, contamination of external geometries can arise due to the atomizing, wherein in particular nozzles, nozzle tubes, interchangeable heads, robot components etc. can be affected. The above problems lead to increased cleaning and maintenance.

According to the invention, the mixing of preservative agent and hardener can preferably take place at an end section of the device in terms of flow, such as in an application device, an application element and/or a nozzle. There is also the possibility of forming the device in such a way that the preservative agent and the hardener can mix in flight (in the air), in a cavity to be preserved and/or on a component to be preserved. The initiation of the mixing preferably takes place in an application device, an application element, a nozzle, in flight (in the air), in a cavity to be preserved and/or on a component to be preserved. Consequently, there is preferably no mixing of preservative agent and hardener upstream from the application device, upstream from the application element, upstream from a nozzle and/or upstream from an outlet opening of a nozzle. In this way the above disadvantages can be completely avoided or at least significantly diminished.

In particular, the device may comprise an application device for applying the preservative agent and the hardener to the component to be preserved, a preservative agent line for feeding the preservative agent to the application device and a hardener line for feeding the hardener to the application device.

The application device can preferably include at least a first application element with at least one first outlet opening. The first application element may be for example an application tube, a lance, a probe, etc.

In a preferred exemplary embodiment the first application element has at least one first nozzle on which is provided the first outlet opening.

The preservative agent line and the hardener line preferably discharge into the first application element in such a way that the preservative agent and the hardener can be mixed in the first application element. The mixing process can be thereby initiated in the application element. It is advantageous here that only few sections come into contact with a mixture of preservative agent and hardener.

It is also possible that the preservative agent line and the hardener line discharge into the first application element in such a way that the preservative agent and the hardener can be mixed immediately upstream from the first nozzle and/or in the first nozzle. The mixing process can thereby be initiated immediately upstream from the first nozzle and/or in the first nozzle. It is advantageous here that only few sections come into contact with a mixture of preservative agent and hardener.

Furthermore, a second outlet opening can be provided on the first nozzle.

The first application element can furthermore have a second nozzle on which is provided a second outlet opening.

The preservative agent line preferably leads to the first outlet opening and the hardener line leads to the second outlet opening in such a way that the preservative agent and the hardener mix in flight and/or on the component to be preserved. The mixing process can be thereby initiated in terms of flow downstream from the outlet openings. The preservative agent and the hardener mix in flight and/or on the component to be preserved. It is advantageous here that no interior sections of the device come into contact with a mixture of preservative agent and hardener.

It is also possible that the application device has a second application element with at least one second outlet opening. Preferably the first and second application element are two separate parts which can be moved and/or controlled independently of one another e.g. can be guided one after the other into a cavity to be preserved. For example, the first application element can be arranged on a first robot arm in a preservative agent application station, whereas the second application element can be arranged on a second robot arm in a hardener application station. The preservative agent application station and the hardener application station may be preferably provided parallel to a conveying route for motor vehicle body components to be preserved.

Similarly to the first application element, the second application element may have a second nozzle on which is provided a second outlet opening.

The preservative agent line preferably leads to the first outlet opening and the hardener line to the second outlet opening in such a way that the preservative agent and the hardener mix in flight and/or on the surface to be preserved. The mixing process can be thereby initiated in terms of flow downstream from the outlet openings. It is advantageous here that no interior sections of the device come into contact with a mixture of preservative agent and hardener.

The first and/or second application element is formed in such a way that it can be guided to hard-to-reach surfaces to be preserved (e.g. cavities, undercuts, etc.). The first and/or second application element can be preferably an application tube, a lance, a probe, etc. The first and/or second outlet opening is preferably provided on this element, preferably on a nozzle. The application element is formed in such a way that, e.g., it can be guided through an opening into a cavity to be preserved in order to spray its inner surface to be preserved with preservative agent and/or hardener.

It is furthermore possible to provide a mixer, in particular in the application device, in an application element, preferably in an application tube, and/or in a nozzle. The mixer can also extend over at least two of the aforementioned sections (e.g. from the application tube to the nozzle). In order to accommodate the mixer e.g. in the nozzle and/or in the application tube, the mixer must have correspondingly small dimensions and nevertheless achieve sufficient mixing results, which conventional mixers are incapable of doing. A suitable mixer for the invention could be manufactured preferably by means of a generative method (e.g. rapid prototyping).

Means could furthermore be provided in order particularly to flow through, coat and or to fill in particular the application device, the application element and/or the first and/or second nozzle with a solvent/rinsing agent, a reactive substance (e.g. a reaction delayer such as an organic acid chloride), which essentially stops or inhibits the hardening, and/or a monofunctional substance (e.g. propanol or butanol, in particular in the case of an isocyanate functionality), which reacts with the preservative agent and/or the hardener to essentially stop or inhibit the hardening (in particular in such a way that its chain reaction is essentially suppressed). The reactive substance and/or the monofunctional substance thereby act as a blocking means in order to delay, preferably essentially to prevent, the hardening of the preservative agent resp. of the mixture comprising preservative agent and hardener. It is possible for the mixture to comprise further components such as a solvent and/or rinsing agent.

The monofunctional substance is preferably a reactive, monofunctional substance which reacts with a preservative agent component and/or a hardener component, preferably with a hardener component, wherein due to its monofunctionality does not lead to polymer chains but in the ideal case to a molecule resp. oligomer comprising a hardener molecule and two blocking agent molecules. Monofunctional substances to consider are particularly amines or alcohols, preferably low alcohols, e.g. ethanol, propanol, butanol and/or their isomers. The reactivity of the chain reaction, which is essentially suppressed by the monofunctional substance, should be greater than that of the chain-forming reaction. Since e.g. bi- or multifunctional hardener molecules react with a short-chain monofunctional molecule, the viscosity of the mixture (preservative agent, hardener, monofunctional substance) remains low.

The reactive substance as such should not penetrate the cavity to be preserved.

As mentioned above, the invention opens up the possibility of forming the device in such a way that the preservative agent and the hardener can be mixed in the device, in the application device, in an application element, in a nozzle, outside the application device, outside an application element, outside outlet openings, in flight (in the air) and/or on the component to be preserved.

For example the preservative agent line and the hardener line can discharge into the first and/or second application element in such a way that the mixing of the preservative agent and of the hardener is initiated in flight, on the component to be preserved and/or in the first nozzle.

It is furthermore possible to apply the preservative agent and the hardener simultaneously and/or sequentially.

It is also possible to arrange the application device on just one robot, preferably on just a single robot arm. However, it is also possible to arrange the first application element on a first robot, preferably on the free end of a robot arm, and to arrange the second application element on a second robot, preferably on the free end of a second robot arm. For example, the robot or robots could be positioned along a conveying route for motor vehicle body components. The invention is not restricted to the above, however, but can also be used e.g. with hand-guided devices, semi-automatic systems, robot systems, waxing machines, etc.

Means can further be provided to atomize the preservative agent and/or the hardener.

Normally a cavity to be preserved has at least one opening out of which the preservative agent can undesirably escape again. The invention opens up the possibility of closing said opening by means of the preservative agent and the hardener. For this purpose, the preservative agent (with and/or without hardener) is preferably conveyed into the cavity to be preserved. The region around the opening is then particularly targeted for provision of hardener. One advantage of this variant worth mentioning above all is the saving of hardener. It is also possible to target the regions around the opening for provision of hardener without the need for the opening to close.

Alternatively, the opening in the cavity to be preserved can also be closed by means of a plug. The plug can be preferably made of metal, plastic, rubber, wax or a self-soluble material (e.g. water soluble parts, ice etc.), which dissolves by itself once the preservative agent has dried.

The invention further comprises a method for preserving components, in particular for the cavity preservation of motor vehicle body components, preferably with a device according to the invention, with which the advantages described above are achievable.

The method distinguishes itself in particular in that in addition to the preservative agent, a hardener is applied to the component to be preserved, which hardener reacts with the preservative agent to cause the preservative agent to harden.

A wax, for example, can be used as the preservative agent while e.g. isocyanate can be used as the hardener. The invention however can also be used with other components, e.g. various paints.

Other advantageous embodiments of the invention are disclosed in the subclaims or are described in the following description of preferred embodiments of the invention making reference to the figures. The figures show as follows:

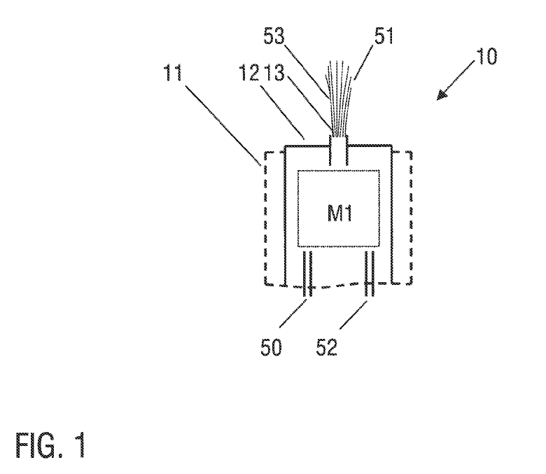

FIG. 1 a schematic representation of a device for preserving components according to a first exemplary embodiment;

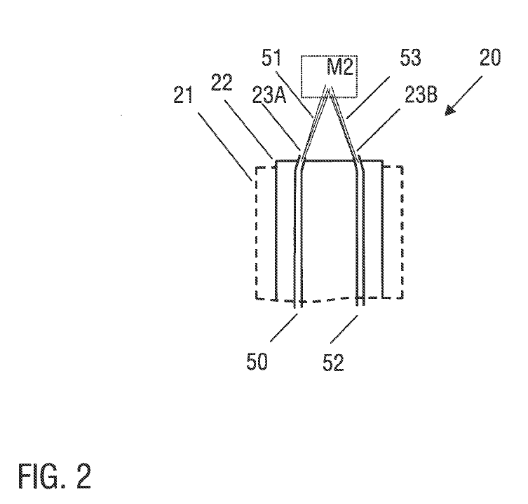

FIG. 2 a schematic representation of a device for preserving components according to a second exemplary embodiment;

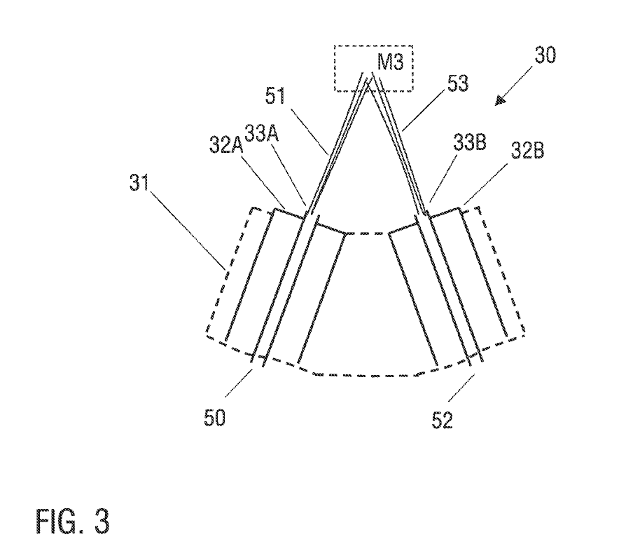

FIG. 3 a schematic representation of a device for preserving components according to a third exemplary embodiment;

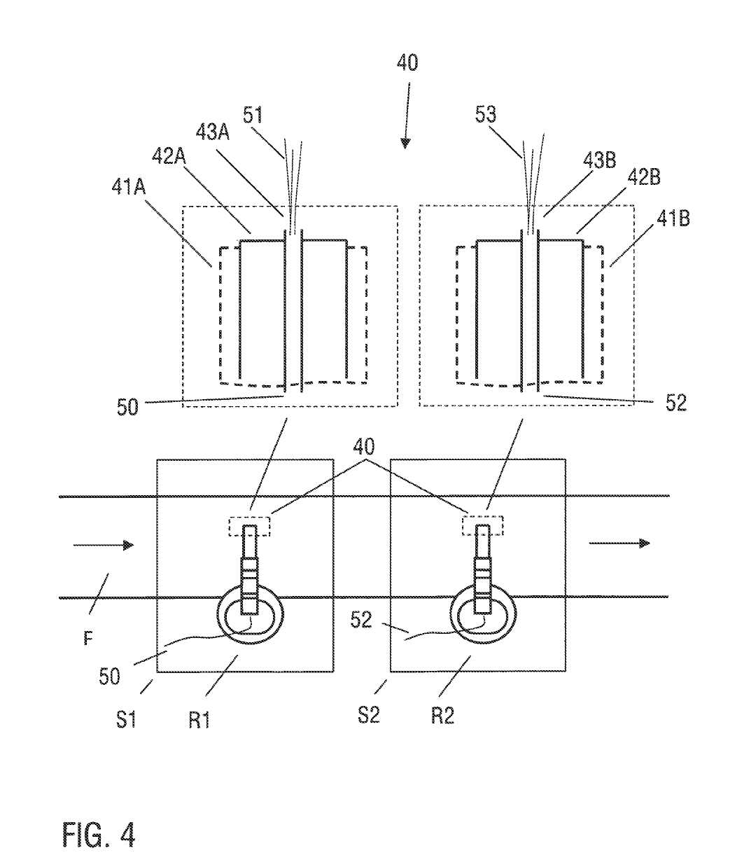

FIG. 4 a schematic representation of a device for preserving components according to a fourth exemplary embodiment.

FIG. 1 is a schematic representation of a device for preserving components according to a first exemplary embodiment, preferably for preserving an inner surface of a cavity. The device is designed in order to apply in addition to a preservative agent a hardener to the component to be preserved, which hardener reacts with the preservative agent and causes the preservative agent to harden.

FIG. 1 shows in particular an application device 10. The application device 10 can be arranged on a robot arm (not shown), preferably on the free end of the robot arm.

According to the first exemplary embodiment the application device 10 comprises an application element 11. The application element 11 is preferably an application tube, which, in terms of flow, essentially represents an end section of the device resp. the application device 10.

On the application element 11, a nozzle 12 is provided. On the nozzle 12, an outlet opening 13 is provided. Furthermore, a preservative agent line 50 is provided for feeding a preservative agent 51 (e.g. wax) to the application device 10 and a hardener line 52 is provided for feeding a hardener (e.g. isocyanate) 53 to the application device 10.

In the first exemplary embodiment, the preservative agent line 50 and the hardener line 52 discharge (open) into the application element 11, preferably into the nozzle 12 provided on the application element 11. Thus, mixing of the preservative agent 51 and of the hardener 53 takes place in the application element 11, i.e. in such a way that the mixing of the preservative agent 51 and of the hardener 53 is initiated in the application element 11. M1 indicates said mixing region within the application element 11. Preferably there is no mixing of the preservative agent 51 and hardener 53 upstream from the application element 11.

As shown in FIG. 1, the preservative agent line 50 and the hardener line 52 discharge into the nozzle 12, which is provided on the application element 11 in such a way that, in the first embodiment, mixing of the preservative agent 51 and of the hardener 53 takes place in the nozzle 12.

It is also possible that the preservative agent line 50 and the hardener line 52 discharge upstream, in particular immediately upstream from the nozzle 12, in such a way that mixing of preservative agent 51 and hardener 53 takes place in the application element 11, preferably in an application tube, and the nozzle 12.

In the application tube 11 and/or the nozzle 12, a mini-mixer can be arranged if required.

FIG. 2 is a schematic representation of a device according to a second exemplary embodiment of the invention. Parts which are similar or identical to the first exemplary embodiment are provided with similar or identical reference numerals in such a way that reference can be made in the description to the first exemplary embodiment to avoid repetition.

FIG. 2 shows in particular an application device 20. According to the second exemplary embodiment, the application device 20 comprises an application element 21. The application element 21 is preferably an application tube, which, in terms of flow, essentially represents an end section of the device resp. the application device 20.

On the application element 21, a nozzle 22 is provided. On the nozzle 22, two outlet openings 23A and 23B are provided. Furthermore, a preservative agent line 50 is provided for feeding a preservative agent 51 to the application device 20 and a hardener line 52 for feeding a hardener 53 to the application device 20.

In the second exemplary embodiment, the preservative agent line 50 leads to the first outlet opening 23A and the hardener line 52 leads to the second outlet opening 23B.

The nozzle 22 resp. the first and second outlet openings 23A and 23B are arranged and/or are positionable in such a way that a mixing of the preservative agent 51 and of the hardener 53 takes place outside the application element 22 in the schematically represented region M2.

The mixing of the preservative agent 51 and of the hardener 53 thereby takes place in flight and/or on a surface to be preserved.

FIG. 3 is a schematic representation of a device according to a third exemplary embodiment of the invention. Parts that are similar parts or identical to the first and/or second exemplary embodiment are provided with similar or identical reference numerals in such a way that reference can be made in the description to the first and/or second exemplary embodiments to avoid repetition.

FIG. 3 shows an application device 30. Similarly to the first and second exemplary embodiment, the application device 30 comprises an application element 31. The application element 31 is preferably an application tube, which, in terms of flow, essentially represents an end section of the device resp. the application device 30.

The application element 31, however, has not just one nozzle but two nozzles 32A and 32B. The first nozzle 32A has a first outlet opening 33A and the second nozzle 32B has a second outlet opening 33B.

Furthermore, a preservative agent line 50 is provided for feeding a preservative agent 51 to the application device 30 and a hardener line 52 for feeding a hardener 53 to the application device 30.

In the third exemplary embodiment, the preservative agent line 50 leads to the first nozzle 32A resp. the first outlet opening 33A in such a way that the preservative agent 51 can be conveyed out of the first outlet opening 33A. The hardener line 52 leads to the second nozzle 32B resp. the second outlet opening 33B, in such a way that the hardener 53 can be conveyed out of the second outlet opening 33B.

The first and second nozzles 32A and 32B resp. the first and second outlet openings 33A and 33B are arranged and/or are positionable in such a way that a mixing of the preservative agent 51 and of the hardener 53 takes place outside the application element 31 in the schematically represented region M3.

Mixing of the preservative agent 51 and of the hardener 53 thereby takes place in flight and/or on a surface to be preserved.

FIG. 4 is a schematic representation of a device according to a fourth example, which is arranged along a conveying route F for motor vehicle body components. Similar or identical parts to the first, second and/or third exemplary embodiments are provided with similar or identical reference numerals in such a way that reference can be made to the descriptions for these exemplary embodiments to avoid repetition.

FIG. 4 essentially shows an application device 40 which is, on the one hand, shown on robots R1, R2 and, on the other hand, shown enlarged. Unlike the previous exemplary embodiments, the application device 40 has two separate application elements 41A and 41B, each of which can be preferably an application tube. In terms of flow, the application element 41A and the application element 41B respectively represent essentially end sections of the device resp. the application device 40.

The first application element 41A can be arranged on a robot arm of a robot R1, preferably on its free end, whereas the second application element 41B can be arranged on a robot arm of another robot R2, preferably on its free end.

The first application element 41A comprises a first nozzle 42A on which a first outlet opening 43A is provided. The second application element 41B comprises a second nozzle 42B on which a second outlet opening 43B is provided.

Furthermore, a preservative agent line 50 is provided for feeding a preservative agent 51 to the application device 40 and a hardener line 52 for feeding a hardener 53 to the application device 40.

In the fourth exemplary embodiment, the preservative agent line 50 discharges to the first nozzle 42A resp. the first outlet opening 43A, in such a way that the preservative agent 51 can be conveyed out of the first outlet opening 43A. The hardener line 52 discharges to the second nozzle 42B resp. the second outlet opening 43B, in such a way that the hardener 53 can be conveyed out of the second outlet opening 43B.

The device for cavity preservation according to the fourth exemplary embodiment is preferably arranged on the conveying route F for transporting motor vehicle body components. The first application element 41A can then be provided in a preservative agent application station S1 and the second application element 41B can be provided in a hardener application station S2. In this process, the hardener application station S2 could be positioned directly downstream from the preservative agent application station S1.

The material, in particular the preservative agent and the hardener, could be preferably matched in such a way that only a defined spreading time is possible after the addition of the hardener. After the preservative agent, preferably a wax, has penetrated, the spreading should be stopped very quickly (“drop-stop”). The hardener application station S2, however, could also be positioned at a distance from the preservative agent application station S1 in accordance with the process time of the penetration. The hardener could then react without delay to initiate the “drop-stop”.

The first and second nozzles 42A and 42B resp. the first and second outlet openings 43A and 43B are provided in such a way that a mixing of the preservative agent 51 and of the hardener 53 can take place outside the application device 40.

Preferably, the discharge of preservative agent 51 and hardener 53 is sequential, i.e. in a first step the first application element 41A applies the preservative agent 51 to the component to be preserved and in a second step the second application element 41B applies the hardener 53 to the component to be preserved. Thus, mixing of the preservative agent 51 and of the hardener 53 preferably takes place on the component to be preserved.

The application device can thus have one application element or a plurality of application elements. In terms of flow, the application device preferably essentially represents an end section of the device. In terms of flow, the application element/s is/are preferably arranged downstream from the application device resp. preferably essentially represent an end section of the device. The application element/s is/are preferably formed in such a way that it/they can position one or a plurality of outlet openings on hard-to-reach surfaces to be preserved e.g. cavities to be preserved, undercuts, etc.

According to the invention, means can be provided to atomize the preservative agent and/or the hardener, as described for example in the disclosure DE 103 22 170 A1, the content of which is to be included in full in the present description.

The invention is preferably usable in manual systems, semi-automatic systems, robot systems, waxing machines, etc. In manual systems resp. semi-automatic systems, a worker guides the corresponding nozzle/s resp. outlet opening/s into the cavity to be preserved and starts the coating process manually. The material quantity can be metered automatically in this process. After completion of the process, the nozzle is conveyed to the next opening and the process is repeated. There are often different nozzles and material quantities and the further process parameters are different for different components on the vehicle. Preferably, a controller can provide information with respect to the nozzle/s to be used, whether and when the nozzle should be changed, the adjustment of relevant parameters, etc. After stripping (start), the coating can proceed fully automatically.

Robot systems are generally used where a high degree of flexibility is required, e.g. body variants, low number of units, changes, etc. The robots preferably have interchangeable heads with one or a plurality of nozzles per head, which interchangeable heads hold the nozzle heads according to the body opening and convey them to the corresponding body openings. The coating can proceed fully automatically.

In the case of waxing machines the body is generally positioned (centred) mechanically. By means of a mechanism, the nozzle/s is/are then inserted into the body openings and the wax is applied. These systems work fully automatically.

The invention is not limited to the above-described preferred exemplary embodiments. Instead, a plurality of variants and modifications is possible, which also make use of the concept of the invention and thus fall within the scope of protection.

1. Device for preserving components with a preservative agent, wherein
the device is configured to apply in addition to the preservative agent a hardener that reacts with the preservative agent, which causes the preservative agent to harden.

2. The device according to claim 1, comprising
an application device configured to applying the preservative agent and the hardener to the component to be preserved;
a preservative agent line for configured to feeding the preservative agent to the application device; and
a hardener line for configured to feed the hardener to the application device.

3. The device according to claim 2, wherein
the application device comprises at least one first application element, with at least one first outlet opening.

4. The device according to claim 3, wherein
the first application element has at least one first nozzle on which the first outlet opening is provided.

5. The device according to claim 3 or 4, wherein
the preservative agent line and the hardener line discharge into the first application element in such a way that the preservative agent and the hardener can be mixed in the first application element.

6. The device according to claim 4, wherein
the preservative agent line and the hardener line discharge into the first application element in such a way that the preservative agent and the hardener can be mixed upstream from the first nozzle or in the first nozzle.

7. The device according to claim 4, wherein a second outlet opening is provided on the first nozzle.

8. The device according to claim 4, wherein
the first application element has a second nozzle on which is provided a second outlet opening.

9. The device according to claim 8, wherein
the preservative agent line leads to the first outlet opening and the hardener line leads to the second outlet opening in such a way that the preservative agent and the hardener mix in flight or on the component to be preserved.

10. The device according to claim 3, wherein
the application device furthermore has a second application element with at least one second outlet opening.

11. The device according to claim 10, wherein the second outlet opening is provided on a second nozzle.

12. The device according to claim 10, wherein
the preservative agent line-leads to the first outlet opening and the hardener line leads to the second outlet opening in such a way that the preservative agent and the hardener can be mixed in flight or on the component to be preserved.

13. The device according to claim 10, wherein the first application element is arranged on a preservative agent application station and the second application element arranged on a hardener application station, wherein the preservative agent application station and the hardener application station are positioned along a conveying route for motor vehicle body components.

14. The device according to claim 10, wherein:
at least one of the first application element and the second application element is formed in such a way that it can be guided into a cavity to be preserved; and
at least one of the first application element and the second application element is an application tube or a probe.

15. The device according to claim 1, wherein
a mixer is provided the mixer disposed in at least one of
an application device;
a first application element;
a first nozzle.

16. The device according to claim 1,
wherein means are provided in order to flow through
at least one of a first and a second nozzle with at least one of
a solvent/rinsing agent;
a reactive substance, which essentially stops or inhibits the hardening;
a monofunctional substance, which reacts with at least one of the preservative agent and the hardener, to essentially stop or inhibit the hardening.

17. The device according to claim 1, wherein
the device is formed in such a way that the preservative agent and the hardener can be mixed in at least one of the following:
in the device;
in an application device;
in a first application element;
in the first nozzle;
outside an application device;
outside at least one of a first and a second application element;
outside at least one of the first and/or second outlet openings;
in flight; and
on the component to be preserved.

18. The device according to claim 10, wherein
the preservative agent line and the hardener line discharge into at least one of the first and the second application element in such a way that the mixing of the preservative agent and of the hardener is initiated in at least one of the following:
in flight;
on the component to be preserved;
in the first application element; and
in the first nozzle.

19. The device according to claim 1, wherein the device is configured such that application of the preservative agent and of the hardener can be executed simultaneously or sequentially.

20. The device according to claim 1, wherein
at least one of a first and a second robot arm is provided along a conveying route for motor vehicle body components; and
at least one of an application device,
a first and a second application element is arranged on at least one of the first and the second robot arm.

21. The device according to claim 1, wherein means are provided to atomize at least one of the preservative agent and the hardener.

22. Method for the preservation of components with a preservative agent,
wherein
in addition to the preservative agent a hardener is applied that reacts with the preservative agent, which causes the preservative agent to harden.

23. The method according to claim 22, wherein
the preservative agent and the hardener are mixed in at least one of the following:
in the device;
in an application device;
in an application element;
in a nozzle;
outside an application device;
outside at least one of a first and a second application element;
outside at least one of a first and a second outlet opening;
in flight; and
on the component to be preserved.

24. The method according to claim 22, wherein
the preservative agent and the hardener are mixed by a mixer.

25. The method according to claim 22, wherein
the preservative agent and the hardener are applied from a first nozzle.

26. The method according to claim 22, wherein
the preservative agent is applied from a first nozzle and the hardener is applied from a second nozzle.

27. The method according to claim 23, wherein
the application of the preservative agent and of the hardener is executed simultaneously or sequentially.

28. The method according to claim 22, wherein
the hardener is applied only to regions around an opening on a cavity to be preserved of the component to be preserved in such a way that remaining regions of the component to be preserved remain essentially hardener-free.

29. The method according to claim 22, wherein
the application of the preservative agent is executed in a preservative agent application station and the application of the hardener in a hardener application station, wherein the preservative agent application station and the hardener application station are positioned along a conveying route for motor vehicle body components.

30. The method according to claim 22, wherein
an opening of the component to be preserved on the cavity to be preserved is closed by the preservative agent and the hardener.

31. The method according to claim 22, wherein
an opening of the component to be preserved on the cavity to be preserved is closed by means of a plug made of a material selected from the group consisting of:
metal;
plastic;
rubber;
wax; and
a self-soluble material, which dissolves by itself once the preservative agent is dried.

32. The method according to claim 22, wherein
at least one of a first and a second nozzle
is flown through with at least one of
a solvent/rinsing agent;
a reactive substance, which essentially stops or inhibits the hardening;
a monofunctional substance, which reacts with at least one of the preservative agent and/or the hardener, to essentially stop or inhibit the hardening.

33. The method according to claim 32, wherein
the flow through is executed
after each motor vehicle body component;
periodically after a predetermined number of body components; or
in pauses.

34. The device according to claim 1, wherein the device is adapted for cavity preservation of motor vehicle body components.
